(19) United States
(12) Patent Application Publication
(10) Pub. No.: US 2005/0207062 A1
(43) Pub. Date: Sep. 22, 2005

(54) Tape Guide decreasing transverse movement of data storage tape at high frequencies

(75) Inventor: Douglas W. Johnson, Stillwater, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/802,437

(22) Filed: Mar. 17, 2004

(51) Int. Cl. G11B 5/09; G11B 15/18; G11B 17/00; G11B 19/02; G11B 15/60

(52) U.S. Cl. 360/130.21

(57) ABSTRACT

A tape guide for use with a data storage tape system including a read/write head. The tape guide includes a bearing portion and a tape interface portion extending from the bearing portion. The tape interface portion is configured to support a data storage tape near the read/write head. Upon longitudinal movement of the data storage tape across the tape interface portion, the tape guide limits a spectral content of data storage tape lateral movement measured at the read/write head to less than 0.1 μm at lateral movement frequencies between 50 and 500 cycles/meter.

### THE FIELD OF THE INVENTION

The present invention generally relates to tape guides for use with data storage tape. More particularly, the present invention relates to tape guides configured to limit transverse movement of the data storage tape at relatively high frequencies.

### BACKGROUND OF THE INVENTION

Magnetic media are a popular form of data storage media, and are used for storage and retrieval of data. Magnetic media come in many forms, such as data storage tapes and data storage disks. A read/write head assembly, which includes one or more read/write transducer heads, writes data to and reads data from the magnetic medium. Data stored in the medium are usually organized into “data tracks,” and the transducer head writes data to and reads data from the data tracks. Data tracks and magnetic tape are generally parallel to each other, and often are orientated substantially longitudinally on the tape.

Typically, the data storage tape incorporating the data tracks extends between two tape reels to define a tape path. The tape path extends over tape guides and past the transducer head, which is transversely orientated with respect to the tape path, for reading or writing to the data storage tape. Due to external vibrations, internal inconsistencies in the data storage tape, the tape reels, the guides, and/or the wrapping of the data storage tape around the tape reels, the data storage tape sometimes wanders transversely or perpendicular to the length of the data storage tape.

For efficient reading and writing, a transducer head must be accurately positioned to read from or write to a particular data track. A servo system or control loop typically is provided to control the positioning of head relative to the data tracks, more particularly, to transversely move the transducer head to follow or mimic the transverse movement of the data storage tape. With this in mind, the data storage tape often includes additional, specialized tracks, called “servo tracks,” to serve as references or landmarks for the servo transducer head. Servo tracks may include magnetic markers or physical marks and, as such, can be detected magnetically or optically, respectively.

Although in servo tracking, the transducer head is able to move transversely across the width of the storage tape to follow the storage tape, conventional data storage tape systems incorporate guides to control or decrease the transverse movement of the data storage tape. The three basic types of guides typically used for guiding the data storage tape are channel guides, compliant guides, and rotating guides. The channel guide is a stationary or fixed guide typically having longitudinal flanges to constrain the amplitude of transverse movement of the data storage tape. In particular, the data storage tape is guided by a surface extending between the two flanges. The fixed channel guides are based on the theory that a hydrodynamic film or cushion of air forms between the data storage tape and the channel guides when the data storage tape is in motion, thereby, reducing friction and wear. However, when the data storage tape is stopped and rests on the channel guides under tension, the data storage tape often sticks to the channel guide. Such stiction makes the initiation of data storage tape movement difficult and may result in damage to the data storage tape or in data storage tape drive failure due to the inability of the data storage tape drive to start data storage tape motion. Stiction is especially a problem with stationary channel guides in hot and/or wet environments.

The compliant guide is a spring loaded guide configured to constrain the overall tape movement. Compliant guides often have problems of their own, such as spring vibration. Typical rotating guides include an outer surface for interacting with the data storage tape laterally or transversely flanked by two flanges extending away from the outer surface. Such guides typically rotate in order to promote low-friction contact between the data storage tape and the outer surface of the rotating guide and to reduce stiction. Once the data storage tape is moved at full speed, air is pulled in between the data storage tape and the outer surface to lift the data storage tape away from the outer surface of the guide to form a film or cushion of air. The cushion of air provides hydrodynamic lift and the data storage tape passes over the guide on the cushion of air without actually contacting the outer surface of the guide.

All three types of tape guides typically include flanges to constrain the transverse movement of the data storage tape as it passes over the respective guide. Although the flanges constrain transverse movement, the edges of the data storage tape may contact the flanges causing a shock to the system forcing the data storage tape to quickly vacillate between the two flanges, thereby inducing high-frequency transverse movement to the data storage tape. Although servo systems, such as the servo system described above, are adept in tracking transverse movement of the data storage tape at low frequencies (i.e., relatively low speed of transverse movement), servo tracking systems often are unable to keep up with similar amplitudes of transverse movement when the transverse movement occurs at a relatively high frequency. As such, when the data storage tape contacts a flange, the induced high frequency causes additional read/write errors since the transducer head is unable to closely track the tape and read from the data tracks. In other words, even where the amplitude of transverse movement is limited by the channel, compliant, or typical rotating guides with flanges, the increased frequency often is too much for even a transducer head utilizing servo tracking to account for. As such, a need exists for a tape guide system that limits transverse movement at relatively high frequencies as the data storage tape passes across the transducer head.

### SUMMARY OF THE INVENTION

One aspect of the present invention relates to a tape guide for use with a data storage tape system including a read/write head. The tape guide includes a bearing portion and a tape interface portion extending from the bearing portion. The tape interface portion is configured to support a data storage tape near the read/write head. Upon longitudinal movement of the data storage tape across the tape interface portion, the tape guide limits a spectral content of data storage tape lateral movement measured at the read/write head to less than 0.1 μm at lateral movement frequencies between 50 and 500 cycles/meter.

Another aspect of the present invention relates to a data storage tape system including a read/write head, a first tape guide, and a second tape guide. The first tape guide is spaced from the read/write head. The second tape guide is spaced from the read/write head opposite the first tape guide. The first and second tape guides are configured to support a data storage tape near the read/write head. Upon longitudinal movement of the data storage tape across the first and second tape guides, the first and second tape guides limit a spectral content of the data storage tape lateral movement measured at the read/write head to less than 0.1 μm at lateral movement frequencies between 50 and 500 cycles/meter.

Another aspect of the present invention relates to a method of controlling error in reading from or writing to a data storage tape. The method includes providing a first tape guide spaced from a read/write head and a second tape guide spaced from the read/write head opposite the first tape guide, supporting the data storage tape between the first and a second tape guide as the data storage tape passes the read/write head, and longitudinally moving the data storage tape across the tape guides and the read/write head. The method further includes limiting a spectral content of the data storage tape lateral movement measured at the read/write head to less than 0.1 μm at lateral movement frequencies between 50 and 500 cycles/meter.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective view of one embodiment of a data storage tape system in accordance with the present invention;

FIG. 2 is a perspective view of one embodiment of a tape guide of the data storage tape system of FIG. 1;

FIG. 3 is a partial side view of a tape interface portion of the tape guide of FIG. 2;

FIG. 3A is a partial side view of a tape interface portion of a prior art tape guide;

FIG. 4 is a detailed view of a portion of the data storage tape system of FIG. 1 as indicated at “A;”

FIG. 5 is a graph illustrating the transverse movement of a data storage tape at a read/write head using conventional tape guides;

FIG. 6 is a graph illustrating a frequency spectrum derived from the graph of FIG. 5;

FIG. 7 is a detailed portion of the graph of FIG. 6;

FIG. 8 is a detailed portion of a frequency spectrum derived from the data storage tape system of FIG. 1;

FIG. 9 is a top view of a dual-reel data storage tape cartridge incorporating the data storage tape system of FIG. 1; and

FIG. 10 is a top view of one embodiment of a tape drive and a single reel cartridge incorporating the data storage tape system of FIG. 1.

### DESCRIPTION OF THE EXEMPLARY EMBODIMENTS

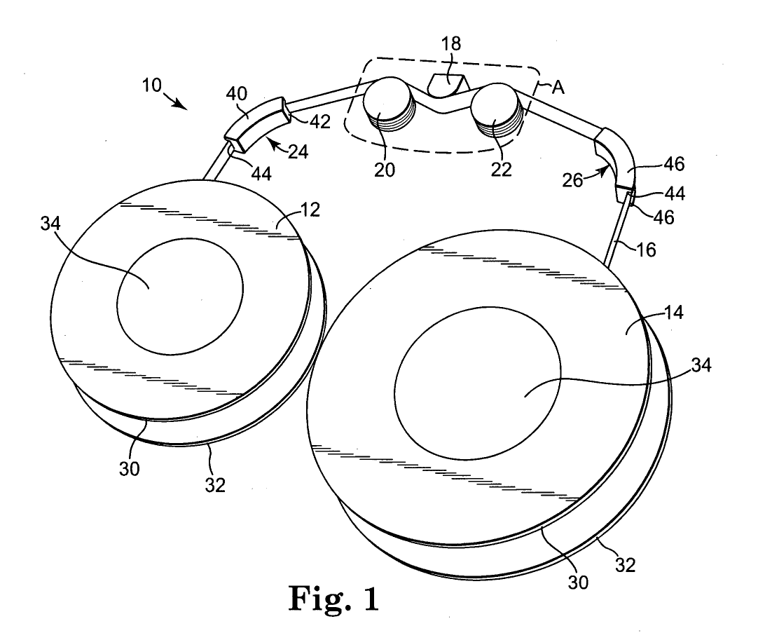

An exemplary data storage tape system 10 according to one embodiment of the present invention is generally illustrated in FIG. 1. The data storage tape system 10 includes a first tape reel 12, a second tape reel 14, a data storage tape 16, a transducer or read/write head 18, a first tape guide 20, and a second tape guide 22. The data storage tape 16 is wound about and extends between the first and second tape reels 12 and 14. In particular, a tape path is defined whereby the data storage tape 16 extends from the first tape reel 12 over the first tape guide 20, past the read/write head 18, over the second tape guide 22, and finally to the second tape reel 14. In one embodiment, the data storage tape system 10 optionally includes a first collateral tape guide 24 and a second collateral tape guide 26 to support the data storage tape 16. The first collateral tape guide 24 is positioned between the first tape reel 12 and the first tape guide 20, and the second collateral tape guide 26 is positioned between the second tape guide 22 and the second tape reel 14. With this in mind, the collateral tape guides 24 and 26 further affect the tape path of the data storage tape 16.

As the data storage tape 16 is advanced along the tape path, lateral movement or movement transverse to the tape path is introduced to the data storage tape 16. The read/write head 18 includes a servo system (not shown), which moves the read/write head 18 in an attempt to follow the transverse movement of the data storage tape 16 at the read/write head. In addition, the first and second tape guides 20 and 22 are configured to attenuate transverse movement of the data storage tape 16 at relatively high frequencies. By decreasing the frequency of transverse movement of the data storage tape 16, the first and second tape guides 20 and 22 facilitate servo tracking of the data storage tape 16 by the read/write head 18 and decrease read/write errors.

In one embodiment, the tape reels 12 and 14 are virtually identical. Each of the first and second tape reels 12 and 14 include opposing flanges 30 and 32 and a central hub generally indicated at 34. The opposing flanges 30 and 32 are laterally spaced along the hub 34 in accordance with a width of the data storage tape 16. More specifically, the flanges 30 and 32 are spaced apart a distance slightly greater than a width of the data storage tape 16. With that in mind, the data storage tape 16 wraps around an outer circumference (not shown) of each of the central hubs 34, laterally constrained by the opposing flanges 30 and 32.

In one embodiment, the data storage tape system 10 optionally includes the first collateral tape guide 24 and the second collateral tape guide 26. The first collateral tape guide 24 is a stationary guide, such as a stationary guide known in the art. In one embodiment, the first collateral tape guide 24 is a stationary channel guide. As such, the first collateral tape guide 24 defines an outer surface 40 flanked by flanges 42 extending outwardly (i.e., away from the read/write head 18) beyond the outer surface 40. The first collateral tape guide 24 is positioned between the first tape reel 12 and the first tape guide 20 to alter the tape path and to allow the data storage tape 16 to smoothly transition from the first tape reel 12 to the first tape guide 20. Notably, the flanges 42 of the first collateral tape guide 24 serve to control the amplitude of transverse movement of the data storage tape 16.

The second collateral tape guide 26 is positioned between the second tape guide 22 and the second tape reel 14. In this respect, the second collateral tape guide 26 alters the tape path to allow the data storage tape 16 to smoothly transition between the second tape guide 22 and the second tape reel 14. The second collateral tape guide 26 is formed in a similar manner as the first collateral tape guide 24 and, therefore, includes an outer surface 44 flanked by the flanges 46. In particular, the data storage tape 16 travels along the outer surface 40 of the first collateral tape guide 24 between the flanges 42. Similarly, the data storage tape 16 travels along the outer surface 26 of the second collateral tape guide 26 between the opposing flanges 46.

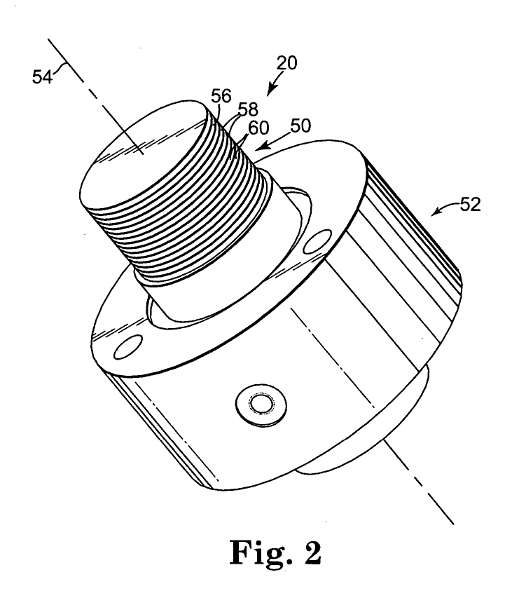

In one embodiment, the first tape guide 20 and the second tape guide 22 are each rotating guides spaced from one another. With additional reference to FIG. 2, the first tape guide 20 includes a tape interface portion 50 and a bearing portion 52. In one embodiment, the tape interface portion is characterized by an absence of flanges. The tape interface portion 50 is substantially cylindrical and rotates about a central axis 54 of the first tape guide 20. The tape interface portion 50 defines an outer surface 56, which circumferentially extends around the tape interface portion 50. The tape interface portion 50 is configured such that the outer surface 56 will have intimate contact with the data storage tape 16 when in use. The data storage tape 16 has intimate contact with the outer surface 56 when the data storage tape 16 directly contacts the outer surface 56 allowing friction to develop between the data storage tape 16 and the outer surface 56 of the tape guide 20 sufficient to limit transverse movement of the data storage tape 16.

In order to have intimate contact between the data storage tape 16 and the outer surface 56 of the first tape guide 20, the tape interface portion 50 is configured to remove the hydrodynamic cushion of air that traditionally forms between a conventional tape guide (not shown), described above in the background section, and the data storage tape 16. Since the first tape guide 20 is configured to promote friction, i.e., to be in intimate contact with the data storage tape 16, the tape interface portion 50 is configured to pull or bleed the air otherwise forming the hydrodynamic cushion away from the outer surface 56 of the first tape guide 20. By removing the hydrodynamic cushion, the data storage tape 16 can have intimate contact with the outer surface 56 as the data storage tape 16 rotates around the tape interface portion 50.

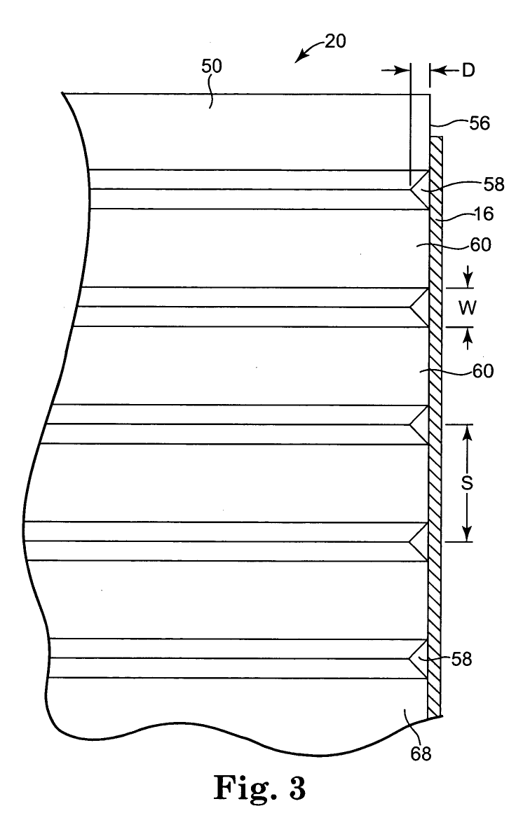

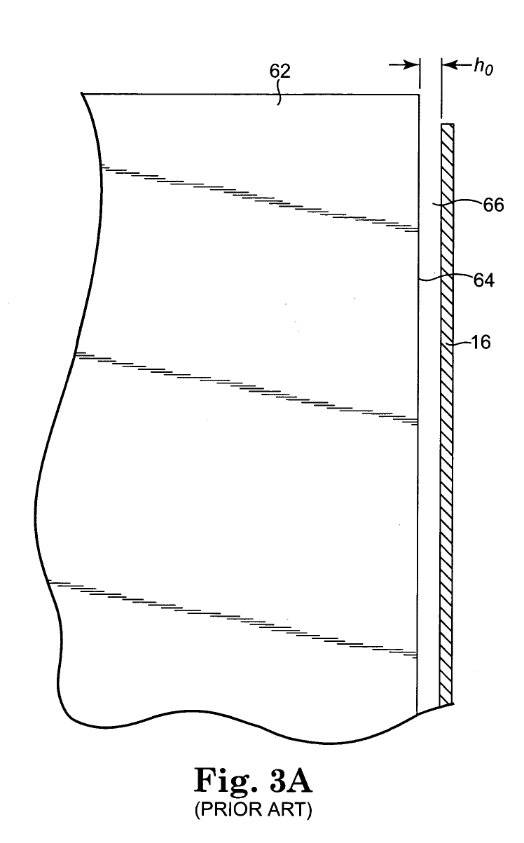

Referring to FIG. 2 and FIG. 3, in one embodiment, to effectuate intimate contact between the data storage tape 16 and the outer surface 56 of the tape interface portion 50, a plurality of circumferential grooves 58 are formed in the tape interface portion 50. In particular, each of the plurality of grooves 58 interrupts the outer surface 56 and extends towards the center axis 54 of the tape interface portion 50. As such, the plurality of grooves 58 are spaced along the outer surface 56 dividing the outer surface 56 into a plurality of treads 60. The grooves 58 are configured to pull or bleed air away from the treads 60, thereby limiting formation of the air bearing or cushion and preventing hydrodynamic lift. By preventing hydrodynamic lift, the plurality of treads 60 have intimate contact with the data storage tape 16 (shown as a cross-section in FIG. 3 for illustrative purposes) as the data storage tape 16 passes over the first tape guide 20.

The design of the grooves 58 is more clearly described with additional reference to FIG. 3A, which illustrates a tape interface portion 62 defining a smooth or non-grooved outer surface 64. Other than having a non-grooved outer surface 64, the tape interface portion 62 is similar to tape interface portion 50. During use of the tape interface portion 62, air is pulled between the data storage tape 16 (shown as a cross-section in FIG. 3A for illustrative purposes) and an outer surface 64 of the tape interface portion 62 in a manner similar to that described with respect to the prior art in the background section to form an air cushion 66. A distance the air cushion 66 extends between the data storage tape 16 and the outer surface 64 is referred to as a fly height h₀. In order to have intimate contact between the outer surface 64, all of the air cushion 66 is removed, in other words, the actual fly height is reduced to zero.

With this in mind, in one embodiment, the grooves 58 (FIG. 3) of the tape interface portion 50 (FIG. 3) are sized and shaped to have a total transverse cross-sectional area greater than an expected transverse cross-sectional area of the air cushion 66 of the corresponding tape interface portion 50. In one embodiment, the expected transverse cross-sectional area of the air cushion 66 is determined by approximating the fly height h₀ of the non-grooved tape interface portion 62. In one embodiment, the fly height h₀ is approximated using the following equation:

$${h}_{o} = K \times R \times {( \frac{12 μ V}{T} )}^{2 / 3}$$

where μ=air viscosity, T=web tension per unit width, R=outer guide radius, K=unitless constant, and V=tape velocity. Notably, unitless constant “K” is empirically derived and, as such, may take on different values depending upon the tape guide conditions observed during its derivation. In one embodiment, constant “K” is equal to 0.65. In another embodiment, constant “K” is more conservatively equal to 1.4.

For example, where the outer surface 64, and thereby the outer surface 56, has a radius of 12.7 mm (0.5 inch), the data storage tape 16 has a tension of 0.1 N/mm (0.57 lb/in), the constant “K” is equal to 1.4, the viscosity of air is equal to 1.85×10⁻¹¹ (2.68×10⁻⁸ lbf-sec/in²), and the data storage tape 16 has a velocity up to 8 m/second (26.25 ft/second), the fly height h₀ approaches 0.0127 mm (0.5 mil). The approximate fly height h₀ multiplied by a width of the data storage tape 16 results in the expected transverse cross-sectional area of the air cushion 66 between the outer surface 64 and the data storage tape 16. As such, for the above-described example in which the data storage tape 16 has a width of 0.5 inch (12.7 mm), the total transverse cross-sectional area of the air cushion 66 is 0.161 mm² (250 mil²). Notably, although the calculation of the expected transverse cross-sectional area of the air cushion 66 is described with reference to FIG. 3A and tape interface portion 62, in actuality, tape interface portion 62 is a hypothetical counterpart of the tape interface portion 50 used for calculation purposes only.

Once the expected transverse cross-sectional of the air cushion 66 is determined, the grooves 58 are designed to have a total transverse cross-sectional area greater than the transverse cross-sectional of the air cushion 66, or in terms of the example greater than 0.161 mm² (250 mil²). In one embodiment, each of the grooves 58 has a similar or identical geometry and is equally spaced along the outer surface 56. In this embodiment, the grooves 58 are defined such that the transverse cross-sectional area of a single groove 58 multiplied by the number of grooves 58 results in a greater total transverse cross-sectional area than the transverse cross-sectional area of the air cushion 66. As such, the transverse cross-sectional area of each groove 58 is inversely proportional to the required number of grooves 58. More precisely, the larger each groove 58, the fewer grooves 58 are needed to bleed away the air cushion 66 and vice versa. In one embodiment, the transverse cross-section of the groove 58 is designed first, followed by selection of the number of and spacing of grooves 58.

For example, utilizing the exemplary numbers described above, in one embodiment, the grooves 58 are V-shaped having a width “W” of 0.254 mm (10 mil) and a depth “D” of 0.127 mm (0.005 inch). With this in mind, each groove 58 has a cross-sectional area of 0.0161 mm² (25 mil²). Therefore, in order to bleed away the entire air cushion 66 having a total cross-sectional area of 0.0161 mm² (250 mil²), more than ten grooves are required. In one embodiment, twelve of the described grooves 58 are equally spaced along the outer surface 56 of the tape interface portion 50, thereby, forming thirteen treads 60.

Although the number of grooves 58 chosen is not critical by itself, generally, the more grooves 58 that are included in the tape interface portion 50, the less wear upon each of the treads 60 and, therefore, the longer lifespan of the tape interface portion 50. However, machine capability, production costs, etc., may limit the number of grooves 58. Therefore, in one embodiment, the number of grooves 58 is selected as a balance of the expected lifespan of the tape interface portion 50 and production machine capabilities, production costs, etc. With this in mind, in one embodiment, the number of grooves 58 is chosen before determining the transverse cross-section of each groove 58.

Notably, although described as having uniformly shaped grooves 58 that are uniformly spaced along the outer surface 56, the plurality of grooves 58 may each have a different transverse cross-sectional area (due to size or shape of each particular groove 58) and/or may be unevenly spaced along the outer surface 56. In such embodiments, the sum of the transverse cross-sectional areas of each groove 58 is greater than the transverse cross-sectional area of the air cushion 66. With this in mind, the resulting plurality of grooves 58 bleed away the entirety of the air cushion 66 from between the treads 60 of the outer surface 56 and the data storage tape 16 allowing data storage tape 16 to have intimate contact with each of the treads 60. Other methods of designing the treads 60 to bleed away the air cushion 66 will be apparent to those of skill in the art.

Furthermore, although described as having a V-shaped cross-section, the grooves 58 may have any shaped cross-section such as rounded, square, trapezoidal, etc. No matter what number or what transverse cross-section is determined for each of the grooves 58, each of the grooves 58 is substantially concentrically positioned along the tape interface portion 50. In particular, the grooves 58 are substantially concentrically, rather than spirally, spaced to prevent the movement of air through the grooves 58 from driving rotation of the tape interface portion 50. Rather, the rotation of the tape interface portion 50 is to be driven primarily, and substantially entirely, by the movement of the data storage tape 16 between the first and second reels 12 and 14 and across the tape interface portion 50.

In one embodiment, the tape interface portion 50 of the first tape guide 20 must have an inertia sufficient to apply mass damping to the data storage tape system 10. A sufficient inertia is normally achieved relatively easily due to the thin nature of the data storage tape 16. In one embodiment, the tape interface portion 50 includes a wall 68 defining the outer surface 56, the wall 68 having a thickness a few orders of magnitude thicker than a thickness of the data storage tape 16. In one embodiment, the data storage tape 16 is approximately 10 μm (0.0394 mil) thick and the tape interface portion 50 is configured with a wall thickness of 1 mm (40 mil) or greater. In one embodiment, the inertia of the tape interface portion 50 is equal to or greater than 6×10⁻⁷ kg-m² (1.4×10⁻⁵ lb-ft²).

Referring once again to FIG. 2, the bearing portion 52 of the first tape guide 20 provides for substantially uniform rotation of the tape interface portion 50 with respect to the bearing portion 52. In one embodiment, the bearing portion 52 includes a roller bearing, an air bearing, or other suitable bearing. Preferably, the bearing portion 52 is configured to prevent damage of the bearing that may cause radial runout. In one embodiment, the bearing portion 52 is configured to have a radial runout better than (i.e., less than) 12.7 μm (0.5 mil). In one embodiment, the bearing portion 52 is configured to have a radial runout better than 0.127 μm (0.005 mil). Notably, the better the radial runout of the bearing portion 52, the less tracking error that occurs. Moreover, the bearing portion 52 is configured for mounting to a base plate, a cartridge, or a disk drive (not shown).

In one embodiment, the second tape guide 22 is substantially similar to the first tape guide 20 described above. With this in mind, the second tape guide 22 also includes a tape interface portion 50 configured and positioned to have intimate contact with the data storage tape 16. In another embodiment, only one of the two tape guides 20 and 22 is configured and positioned to have intimate contact with the storage tape 16, and the other tape guide 20 or 22 is similar to a conventional tape guide (not shown). In one embodiment, the first tape guide 20 is configured and positioned to have intimate contact with the data storage tape 16, and the second tape guide 22 is not configured and positioned to have intimate contact with storage tape 16. In such an embodiment, the second tape guide 22 can be a guide suitable for supporting the storage tape 16 near the read/write head 18. However, preferably, both the first and second tape guides 20 and 22 have intimate contact with the data storage tape 16.

In one embodiment, the first and second tape guides 20 and 22 are positioned as close as possible to the read/write head 18 without interfering with interaction between the read/write head 18 and the data storage tape 16. More specifically, the closer the tape guides 20 and 22 are positioned with respect to the read/write head 18, the less likely additional or unexpected motion or longitudinal stress waves will be imparted to the storage tape 16 between the tape guides 20 and 22. The less additional motion or stress waves introduced between the tape guides 20 and 22, the more predictable the motion of the data storage tape 16 between the tape guides 20 and 22, and therefore, the read/write head 18 incorporating a servo system (not shown) will more aptly be able to follow the motion of this data storage tape 16 leading to fewer read/write errors.

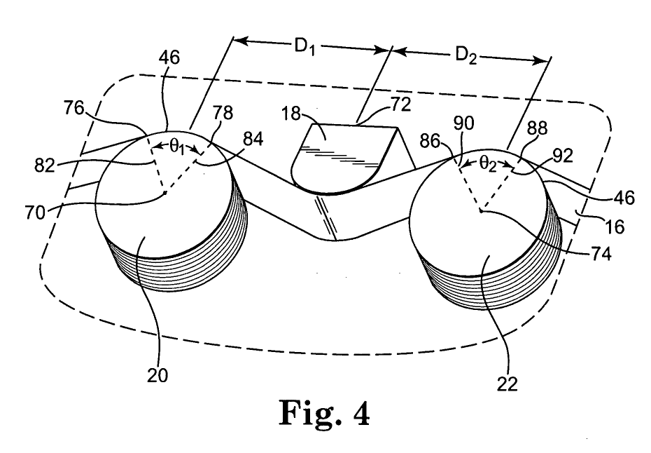

In particular, referring to the detailed view of FIG. 4, a center 70 of the first tape guide 20 is spaced a distance D₁ from a center 72 of the read/write head 18. Similarly, a center 74 of the second tape guide 22 is spaced a distance D₂ from the center 72 of the read/write head 18. In one embodiment, D₁ and D₂ are each equal to or less than twice the width of the data storage tape 16. More particularly, in an embodiment using 12.7 mm (0.5 inch) wide storage tape 16, D₁ and D₂ are each equal to or less than 25.4 mm (1 inch).

Referring to FIG. 1 and FIG. 4, the first and second tape guides 20 and 22 are each positioned with respect to the read/write head 18 and the reels 12 and 14 (or optionally the collateral guides 24 and 26) to define a degree of wrap θ₁ and θ₂, respectively. More specifically, with respect to the first tape guide 20, the degree of wrap θ₁ is determined by first identifying the center 70, a first tangency point 76, and a second tangency point 78 of the tape interface portion 50. Considering the first reel 12 to be the supply reel, the first tangency point 76 is positioned on the outer surface 56 of the tape interface portion 50 where the data storage tape 16 first contacts the outer surface 56 of the tape interface portion 50. The second tangency point 78 is positioned on the outer surface 56 of the tape interface portion 50 where the data storage tape 16 leaves or ceases contact with the outer surface 56. A first reference line 82 is drawn between the center 70 and the first tangency point 76, and a second reference line 84 is drawn between the center 70 and the second tangency point 78. The degree of wrap θ₁ for the first tape guide 20 is defined between the two reference lines 82 and 84.

The degree of wrap θ₂ for the second tape guide 22 is similarly defined by identifying the center 74, a first tangency point 86, and a second tangency point 88 along the outer surface 56 of the second tape guide 22. The first tangency point 86 is positioned on the outer surface 56 where the data storage tape 16 first contacts the outer surface 56. The second tangency point 88 is positioned where the data storage tape 16 leaves or ceases to contact the outer surface 56. A first reference line 90 is drawn between the center 74 and the first tangency point 86, and a second reference line 92 is drawn between the center 74 and the second tangency point 88. The degree of wrap θ₂ of the second tape guide 22 is defined between the two reference lines 90 and 92.

The two degrees of wrap θ₁ and θ₂ are each sufficiently large to foster the friction or intimate contact between the data storage tape 16 and each of the tape guides 20 and 22 to limit the frequency of transverse movement of the data storage tape 16 with respect to the tape guides 20 and 22. In one embodiment, the tape guides 20 and 22 each have a degree of wrap θ₁ and θ₂ of greater than 30°. As such, the intimate contact between the data storage tape 16 and tape guides 20 and/or 22 occurs over a degree of wrap θ₁ and/or θ₂, respectively, and is sufficient to limit or decrease the frequency of transverse movement of the data storage tape 16 with respect to the tape interface portions 50 of the first and second tape guides 20 and 22.

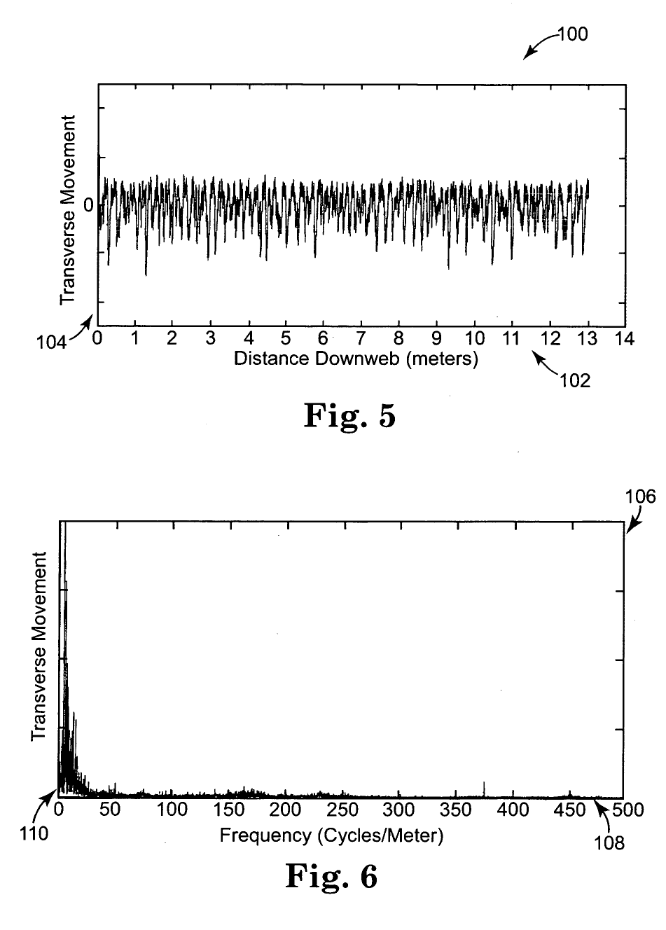

By having intimate contact with the data storage tape 16, each of the tape guides 20 and 22 decreases the amplitude of transverse movement at high-range frequencies. For example, FIG. 5 illustrates an exemplary tape motion graph 100 for a conventional tape guide (not shown) including an X-axis 102 corresponding to the distance downweb or longitudinal distance along the data storage tape 16 and a Y-axis 104 corresponding to the transverse movement of the data storage tape 16 at the read/write head 18. As such, the tape motion graph 100 illustrates the near constant transverse movement of the data storage tape 16 as it passes the read/write head 18. It is this transverse movement that the read/write head 18 with servo system attempts to follow.

Taking the Fourier Transform of the tape motion graph 100 generates a frequency spectrum graph 106 of the transverse movement of the data storage tape 16 as illustrated in FIG. 6. The frequency spectrum graph 106 includes an X-axis corresponding to frequency of transverse movement of the data storage tape 16 and a Y-axis corresponding to the amplitude or amount of transverse movement of the data storage tape 16. Notably, since the data storage tape 16 is typically driven longitudinally along the tape path at a known constant speed, the frequency is expressed in cycles/meter rather than in traditional Hertz units. More specifically, a frequency measurement in Hertz divided by the longitudinal speed of the data storage tape 16 provides the frequency expressed in cycles/meter. With this in mind, frequency expressed in cycles/meter can be directly compared independent of the longitudinal speed of the data storage tape 16.

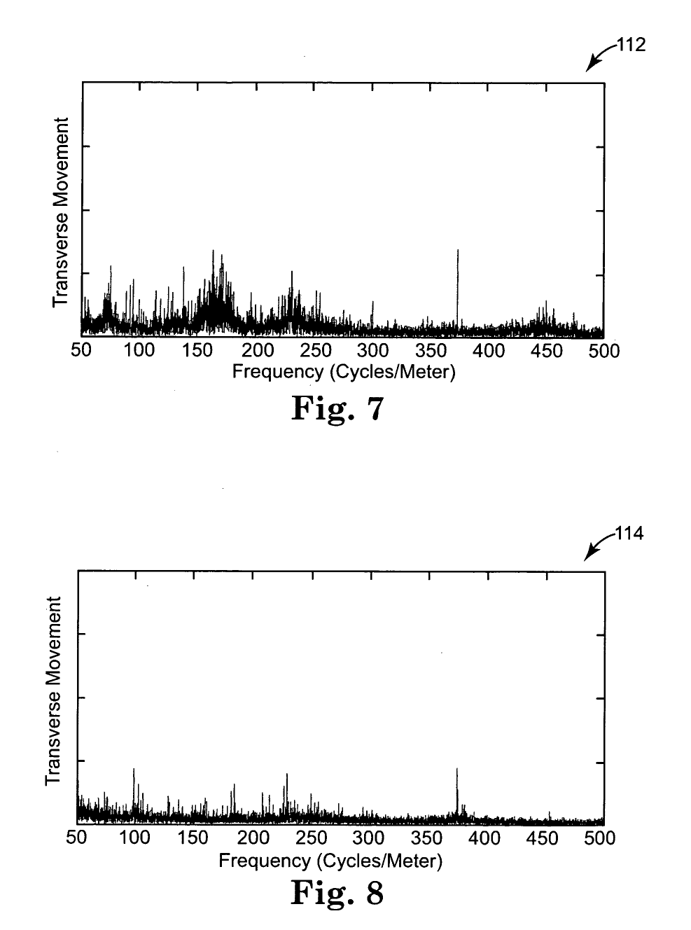

The frequency spectrum graph 106 illustrates that a majority of the data storage tape 16 transverse movement occurs at relatively low frequencies in the range of 0-50 cycles/m (0-15.25 cycles/ft). Generally, the read/write head 18 having a servo system (not shown) is able to follow transverse motion of the data storage tape 16 in the relatively low frequency range of 0-50 cycles/m (0-15.25 cycles/ft). Although transverse motion of the data storage tape 16 at the relatively high frequencies occurs with considerably less amplitude (less magnitude of transverse movement), the transverse movement at the relatively high frequencies, 50-500 cycles/m (15.5-152.50 cycles/ft), causes a predominance of the read/write error, in other words, causes problems for the servo read/write head 18. In FIG. 7, an enlarged frequency spectrum graph 112 is illustrated more clearly showing the magnitude of transverse movement at the relatively high frequencies.

By having intimate contact between the data storage tape 16 and the tape guides 20 and 22, the tape guides 20 and 22 each serve to limit the transverse movement of the data storage tape 16 in the relatively high frequency range of 50-500 cycles/m (15.25-152.50 cycles/ft). This impact is illustrated in FIG. 8 in a frequency spectrum graph 114 for the transverse movement at the read/write head 18 between the tape guides 20 and 22, which is comparable to the frequency spectrum graph 112 for conventional tape guides. By comparing the frequency spectrum graph 112 for conventional tape guides to the frequency spectrum graph 114 with tape guides 20 and 22, the impact of the tape guides 20 and 22 to limit transverse movement in the high frequency range is clear.

The impact of the tape guides 20 and 22 is further quantified by determining a spectral content of the tracking error for the frequency range of 50-500 cycles/m (15.25-152.50 cycles/ft). The spectral content of the tracking error, i.e., the standard deviation of the overall contribution to tracking error, is determined by the following equation:

$$Spectral Content = \sqrt{{\sum }_{i} {( {rangeFFT}_{i} )}^{2}}$$

Where rangeFFTᵢ are the discrete amplitudes of the transverse motion at the read/write head 18 of the data storage tape 16 for each frequency value within the range of interest, in this case, within the frequency range of 50-500 cycles/m (15.25-152.50 cycles/ft). In one embodiment, the spectral content standard deviation for a tape drive system 10 with tape guides 20 and 22 is less than 0.100 μm (0.0039 mil). In one embodiment, the tracking error standard deviation for a tape drive system 10 with tape guides 20 and 22 is less than 0.075 μm (0.0030 mil).

For example, the tracking error standard deviation for the frequency spectrum graph 112 using conventional tape guides (not shown) is 0.113 μm (0.0044 mil). On the other hand, the tracking error standard deviation for the frequency spectrum graph 114 using tape guides 20 and 22 is 0.058 μm (0.0023 mil), which notably, is a little more than half the tracking error standard deviation for the frequency spectrum graph 112 using conventional tape guides. While the improvement in the spectral content improves read/write quality using data storage tape 16, the improved spectral content is increasingly important as data density is continually increasing in an attempt to achieve 3000 or more data tracks per inch of width of the data storage tape 16.

In addition to problems caused by transverse movement of the data storage tape 16, longitudinal stress or pressure waves will also cause error to read/write heads 18 with servo systems. Stress or pressure waves travel longitudinally through the storage tape 16 between the first and second reels 12 and 14. In particular, the longitudinal stress waves are generally initiated at the first and second reels 12 and 14 and travel longitudinally through the data storage tape 16. While providing for intimate contact between the storage tape 16 and the tape guides 20 and 22, as described above, the tape guides 20 and 22 also serve as nodes that stop the longitudinal stress waves from proceeding along the length of the data storage tape 16. The first and second tape guides 20 and 22 actually reflect the longitudinal stress waves back toward the respective tape reel 12 or 14.

More specifically, longitudinal stress waves traveling from the first tape reel 12 toward the first tape guide 20 are reflected back toward the first reel 12 and, thereby, stop or decrease the longitudinal stress waves from traveling past the first tape guide 20 toward the read/write head 18. In addition, the longitudinal stress waves traveling from the second tape reel 14 toward the second tape guide 22 are reflected back toward the second tape reel 14, and thereby, stop or decrease the longitudinal stress waves from traveling past the second tape guide 22 toward the read/write head 18. As such, the two tape guides 20 and 22 serve to prevent or limit the magnitude of longitudinal stress waves traveling through the data storage tape 16 as the data storage tape 16 passes over the read/write head 18 and, thereby, further decrease tracking error in read/write head servo systems (not shown) incorporating timing measurements (i.e., read/write head servo systems further controlling the position of the read/write head 18 within the data tracks to reduce position signal error). In one embodiment, the tape guides 20 and 22 contribute to a velocity error less than 0.05%.

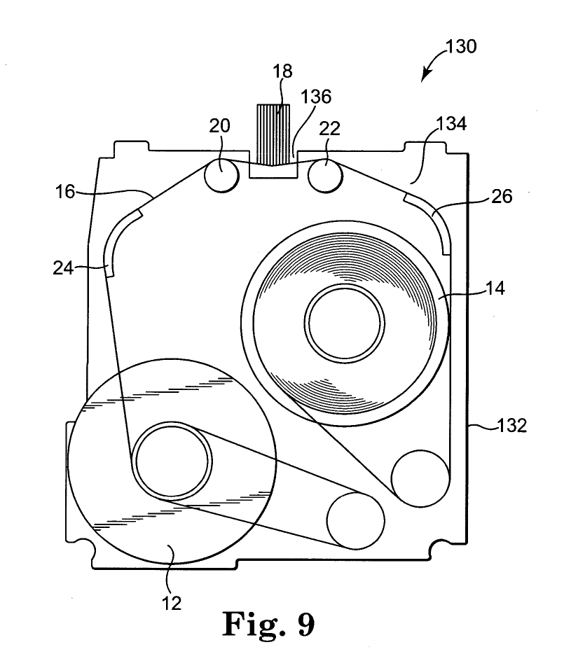

One embodiment of a dual-reel cartridge incorporating the data storage tape system 10 is generally illustrated in FIG. 9 at 130. The dual-reel cartridge 130 includes a cartridge housing, a portion of which is generally illustrated at 132. A base plate 134 is maintained within the bottom of the cartridge housing 132. Each of the first reel 12, the second reel 14, the first tape guide 20, the second tape guide 22, the first collateral tape guide 24, and the second collateral tape guide 26 are coupled to the base plate 134. More specifically, the first and second reels 12 and 14 and the first and second tape guides 20 and 22 are rotatably coupled to the base plate 134. The cartridge housing 132 defines an access window 136 between the first and second tape guides 20 and 22.

Upon insertion into a dual-reel tape drive (not shown), the read/write head 18 included in the tape drive accesses the data storage tape 16 through the access window 136. Notably, the tape path of the data storage tape 16 travels between the first tape guide 20 and the second tape guide 22 through or near the access window 136. The read/write head 18, thereby, contacts the data storage tape 16 to read from or write to the data storage tape 16. Due to the positioning and configuration of the first and second tape guides 20 and 22, the read/write head 18 is able to track transverse movement of the data storage tape 16 with respect to the first and second tape guides 20 and 22. Additionally, the first and second tape guides 20 and 22 limit the longitudinal pressure waves traveling through the data storage tape 16, thereby, further limiting read/write error.

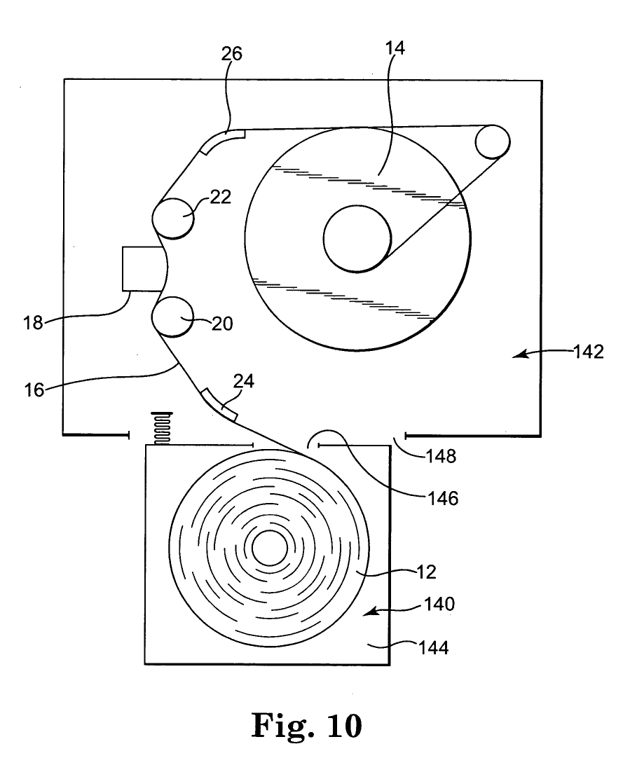

One embodiment of a single reel cartridge 140 and a single reel tape drive 142 incorporating the data storage tape system 10 is generally illustrated in FIG. 10. The single reel cartridge 140 generally includes a cartridge housing 144, which substantially encloses the second reel 14 that is rotatably coupled to the cartridge housing 144. The cartridge housing 144 defines an access window 146. The data storage tape 16 travels through the access window 146 into and out of the single reel tape drive 142. The single reel tape drive 142 includes the second reel 14, the read/write head 18, the first tape guide 20, the second tape guide 22, the first collateral tape guide 24, and the second collateral tape guide 26. The single reel tape drive 142 includes a drive opening 148 to selectively receive the single reel cartridge 140. More specifically, the access window 146 of the single reel cartridge 140 is accessed through the drive opening 148. As such, the tape path of the data storage tape 16 extends from single reel cartridge 140 through the access window 146 and the drive opening 148 into and through the tape drive 142.

Once again, the first and second tape guides 20 and 22 are configured and positioned to have intimate contact with the data storage tape 16 to limit the transverse movement of the data storage tape 16 with respect to the tape guides 20 and 22. Additionally, in one embodiment, the first and second tape guides 20 and 22 further prevent or decrease the magnitude of longitudinal stress waves traveling throughout the data storage tape 16 between the first tape guide 20 and the second tape guide 22, thereby, further decreasing read/write error and allowing the servo read/write head 18 to more easily track the data storage tape 16 during transverse movement.

By incorporating tape guides that have intimate contact with the data storage tape and positioned relatively near the read/write head, the magnitude of transverse movement of the data storage tape is decreased at relatively high frequencies. The decrease in high-frequency, transverse movement permits the read/write head with a servo system to more accurately track the transverse movement of the data storage tape. Since the transverse movement of the data storage tape is more accurately tracked, read/write errors are decreased. Moreover, decreased read/write errors allow the data storage tape to be formed with a higher data track density than would otherwise be allowed.

Although specific embodiments have been illustrated and described herein, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate the present invention may be implemented in a very wide variety of embodiments. This application is intended to cover any adaptations or variations of the embodiments discussed herein. Therefore, it is manifestly intended that this invention be limited only by the claims and the equivalence thereof.

1. A tape guide for use with a data storage tape system, the tape guide comprising:
a bearing portion; and
a tape interface portion extending from the bearing portion, the tape interface portion configured to support a data storage tape near a read/write head;
wherein upon longitudinal movement of the data storage tape across the tape interface portion, the tape guide limits a spectral content of data storage tape lateral movement measured at the read/write head to less than 0.1 μm at lateral movement frequencies between 50 and 500 cycles/meter.

2. The tape guide of claim 1, wherein the tape interface portion rotates with respect to the bearing portion.

3. The tape guide claim 2, wherein the radial runout of the tape guide is less than 0.5 mil.

4. The tape guide of claim 1, wherein the tape interface portion includes an outer surface configured and positioned to have intimate contact with the data storage tape as the data storage tape passes over the tape interface portion.

5. The tape guide of claim 1, wherein the outer surface includes a plurality of substantially concentric grooves.

6. The tape guide of claim 5, wherein the plurality of substantially concentric grooves are configured to remove air from between the data storage tape and the outer surface of the tape interface portion.

7. The tape guide of claim 1, wherein the tape interface portion is characterized by the absence of flanges.

8. A data storage tape system comprising:
a read/write head configured to read from or write to a data storage tape;
a first tape guide spaced from the read/write head; and
a second tape guide spaced from the read/write head opposite the first tape guide, the first and second tape guides configured to support the data storage tape near the read/write head;
wherein upon longitudinal movement of the data storage tape across the first and second tape guides, the first and second tape guides limit a spectral content of the data storage tape lateral movement measured at the read/write head to less than 0.1 μm at lateral movement frequencies between 50 and 500 cycles/meter.

9. The data storage tape system of claim 8, wherein at least one of the first and second tape guides is a rotating guide and the radial runout of each of the rotating guides is less than 0.5 mil.

10. The data storage tape system of claim 8, wherein at least one of the first and second tape guides is configured and positioned to have intimate contact with the data storage tape as the data storage tape passes over the respective tape guide.

11. The data storage tape system of claim 8, wherein both of the first and second tape guides are configured and positioned to have intimate contact with the data storage tape as the data storage tape passes over the respective tape guide.

12. The data storage tape system of claim 8, wherein at least one of the first and second tape guides defines an outer surface that includes a plurality of substantially concentric grooves configured to remove air from between the data storage tape and the outer surface of the respective tape guide.

13. The data storage tape system of claim 8, wherein a center of the first tape guide and the second tape guide are each spaced from a center of the read/write head less than twice the width of the length of data storage tape.

14. The data storage tape system of claim 8, wherein the first tape guide interacts with the length of data storage tape to define a degree of wrap greater than 30°.

15. That data storage tape system of claim 14, wherein the second tape guide interacts with the length of data storage tape to define a degree of wrap greater than 30°.

16. The data storage tape system of claim 8, wherein the first and second tape guides are maintained in a data storage tape cartridge.

17. The data storage tape system of claim 8, wherein the first and second tape guides are maintained in a data storage tape drive.

18. The data storage tape system of claim 8, wherein the first and second tape guides decrease the magnitude of the longitudinal stress waves in the data storage tape traveling between the first and second tape guides.

19. The data storage tape system of claim 8, further comprising:
a first collateral tape guide spaced from the first tape guide opposite the read/write head; and
a second collateral tape guide spaced from the second tape guide opposite the read/write head;
wherein the first and second collateral tape guides limit the amplitude of tape transverse movement across the first and second collateral tape guides, respectively.

20. A method of controlling error in reading from or writing to a data storage tape, the method comprising:
providing a first tape guide spaced from a read/write head and a second tape guide spaced from the read/write head opposite the first tape guide;
supporting the data storage tape between the first and a second tape guides, as the data storage tape passes the read/write head;
longitudinally moving the data storage tape across the tape guides and the read/write head; and
limiting a spectral content of the data storage tape lateral movement measured at the read/write head to less than 0.1 μm at lateral movement frequencies between 50 and 500 cycles/meter.
